(19) United States
(12) Patent Application Publication
(10) Pub. No.: US 2006/0072143 A1
(43) Pub. Date: Apr. 6, 2006

(54) Telecommunications services apparatus and methods in mobile telephony messaging

(76) Inventor: Jeffrey Wilson, Hampshire (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/540,363

(22) PCT Filed: Dec. 22, 2003
(86) PCT No.: PCT/GB03/05592

§ 371 Date: Jun. 23, 2005

(30) Foreign Application Priority Data
Dec. 23, 2002 (GB) 0229777.8

(51) Int. Cl. G06F 3/12

(52) U.S. Cl. 358/1.15

(57) ABSTRACT

A mobile telephone network utilises a first message delivery function such as a text message function. An SMS router (2) identifies a characteristic in a message signal, and diverts the message signal to a message processing means (3). The message processing means (3) translates a short form destination address in the message signal into a full destination address for a second. message delivery function such as an email function, the address translation being effected by means of a predefined syntax. The message processing means (3) can then receive a reply email from the original destination address, and can forward the reply to the originator of the original message signal having converted it from email form to text message form.

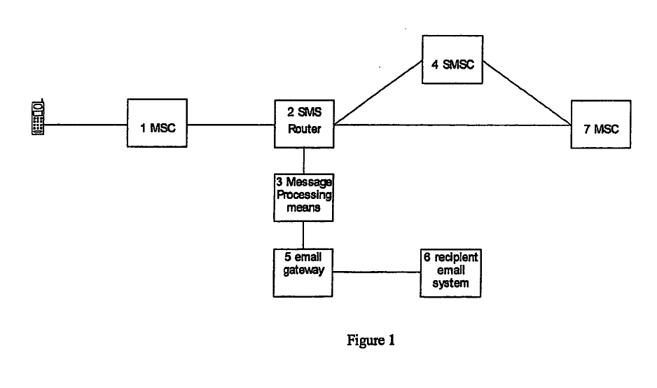

This invention relates to telecommunications services apparatus and methods, such as in the field of mobile telephony text messaging.

Text messaging is established as a popular and effective means of communication for users of mobile telephones. The Short Message Services (SMS) of the GSM mobile telephony system provide an example of such a text messaging facility, and support for the composition, transmission and reception of Short Messages is present in the majority of GSM mobile terminals. SMS text messaging requires alphanumeric entry using the standardised Man Machine Interface (MMI) of the mobile handset, and also requires that the message be addressed to the desired recipient. Other forms of text messaging include EMS (Enhanced Messaging Service), MMS (Multimedia Messaging Service) and all such forms of text messaging are inclusively referred to be the term text messaging for the remainder of this document.

The destination address for a text message may typically be specified either by entering a Mobile Station ISDN number (MSISDN), that is the mobile telephone number of a desired recipient, or by selecting an entry from the handset's address book that already has the desired MSISDN or other address pre-programmed in. The address book normally provides the address by using alphanumeric look-up of a name.

The text messaging mechanism was originally defined for voice mail alerts in the form of SMS, and was extended to mobile-to-mobile text messaging, and later used for communication between mobiles and fixed entities in the network known as SMS Hosts. SMS Hosts are typically used for receiving the results of SMS voting events, or transmitting messages such as football results in bulk to users who subscriber to a premium service for example. SMS Hosts are responsible for an increasing proportion of SMS traffic.

One of the features of text messaging is that an identifier corresponding to the sender's identity is normally transmitted to the recipient. For example, in the GSM Short Message Service (SMS) it may not normally be optionally withheld by the sender. Exceptions to this include certain specialised services which may be offered by an operator, such as chat or dating whereby an alternative or temporary CLI is presented to the recipient, permitting reply but obscuring the originator's identity. Apart from such exceptions, the Calling Line Identity (CLI) is normally sent and may be displayed in the form of an MSISDN, though most handsets will translate this to an alphanumeric name if there is a corresponding MSISDN entry in the handset's address book. This provides ease of recognition of the sender, without the recipient having to remember telephone numbers. The mobile CLI feature is analagous to the CLI facility available on fixed networks. Another benefit of receiving CLI is that a reply to the message is more easily achieved, without having to explicitly specify the return address. The MMI for mobile handsets in GSM defines “Reply” as a standard feature.

As an alternative to transmission of the CLI identifier as an MSISDN, the GSM system also supports, for mobile terminated messages, the transmission of a short Alphanumeric value or name of up to 11 characters instead. Support for reception and correct display of an Alphanumeric CLI is widely available on recent mobile telephones. This facility is being used increasingly by SMS Hosts to brand the messages that are sent to subscribers. In most cases, telephone numbers associated with SMS Hosts or companies originating brand-related SMS traffic would not be pre-programmed into recipients' handsets. The CLI of such messages would therefore carry no value to the user in promoting or recognising the identity of the message source. By using an alphanumeric CLI (such as ‘Coca-Cola’ (RTM) or ‘Hertz’ (RTM)) the user is immediately able to recognise the source, instead of receiving a message from an unrecognised number.

By using the built-in reply function, most handsets are able to reply to a message that had an alphanumeric CLI, although in most cases the network will not support delivery of such a reply message. In this case, the alphanumeric address becomes the destination address of the reply message.

In many cases, handsets are also able to originate messages with an alphanumeric destination address, and as services that make use of alphanumeric addresses increase in popularity it is likely that handset manufacturers will also improve the MMI in this area.

It is known for a mobile subscriber to be able to send a text message from a mobile handset and to have the message delivered as an email to a specified email address. However the syntax for specifying the email address on the mobile handset is cumbersome and slow, and hence the facility when offered by a network is relatively little used. A further disadvantage of this arrangement is that the user must know in advance the desired destination email address. Although the domain name of many companies can be guessed, the complete email address of a company department that is able to handle messages or queries sent by email is generally not guessable.

An additional complexity of such SMS to email services is that the reply path requires a correlation mechanism. When a message is originated from an email address and delivered to a mobile telephone, it is desirable that the mobile user should be able to reply to the sender using the SMS Reply function of the handset's MMI. To do this the CLI field of the original message delivered to the handset must contain a valid reply address. Since this can be either an MSISDN number or an 11 character alphanumeric string, it is not generally possible to directly store an email address there since it would usually be too long. Consequently the network must maintain a correlation mechanism. A special CLI value is generated and sent to the mobile handset with the message. The network stores the CLI value and the corresponding sender's email address. When the user replies, the special CLI is used as the destination address. This address causes the text message to be directed to the network's SMS-to-email gateway, where the corresponding destination email address is looked up and substituted.

A further shortcoming of current SMS addressing means is that it is not generally possible to call someone's mobile telephone number if you do not know it, even though you may know their company name and extension number. Virtual private network (VPN) services allow this but only if the caller belongs to the same closed user group.

People within the same company VPN may call each other using short numbers, but outsiders cannot make use of this facility.

According to one aspect of the invention there is provided a telecommunications services apparatus for use with a mobile telephone network utilising a first message delivery function, the apparatus comprising routing means for identifying a characteristic in a message signal received in the telephone network, and message processing means for translating a short form destination address in the message signal into a fill destination address for a second message delivery function different from the first delivery function, the address translation being effected using a predefined syntax, and the routing means being operable to send the message signal to the message processing means in response to identification of the characteristic in the message signal.

According to another aspect of the invention, there is provided a telecommunications services method for a mobile telephone network utilising a first message delivery function, the method comprising identifying a characteristic in a message signal received in the telephone network, and translating a short form destination address in the message signal into a full destination address for a second message delivery function different from the first delivery function, the address translation being effected using a predetermined syntax, and the message signal being routed for message processing in response to identification of the characteristic in the message signal.

Further aspects of the invention provide a computer program for carrying out the above method, and a storage medium on which such computer program is stored.

At least the preferred embodiment of the present invention addresses the above-described problems, allowing short-form specification of both certain classes of email addresses and VPN numbers for certain companies, using only the 11 character field available in an alphanumeric destination address.

For the email address case, it may be observed that there are a limited number of service providers that have achieved mass-market penetration, such that their email domain names are immediately recognisable by people who regularly use email. Examples include hotmail.com, yahoo.com, aol.com and others. Consequently, useful compression of the email address may be obtained by representing one or more of these common providers as a shortform part of an alphanumeric address that may be entered on a mobile telephone.

In an embodiment of the invention, the exemplified service providers might be represented as follows:

| Service provider email domain | Possible shortform |
|---|---|
| @Hotmail.com | <partial address ending with> @ |
| @Yahoo.com | <partial address ending with> @y |
| @Aol.com | <partial address ending with> @a |

Using these examples, a mobile phone user would be able to send an email message to a destination email address jsmith@hotmail.com simply by sending a text message to the alpha address jsmith@

The suffix@ would be recognised by the network as a shortform for @hotmail.com. The alphanumeric address would be translated by the network to a destination email address jsmith@hotmail.com, and the message delivered by email. The prefix (in this case jsmith) could currently be up to 10 characters long maximum, although future standardisation work may lead to enhanced alphanumeric capabilities in GSM and other mobile network technologies.

It is also possible to define the absence of a suffix, or the absence one of a set of suffices, to indicate a particular short form representation. For example the absence of the such a suffix could be defined as indicating part of a Hotmail address:

| Service provider email domain | Possible shortform |
|---|---|
| @Hotmail.com | <partial address ending with no |
| | suffix> |

Using this example, a mobile phone user would be able to send an email message to a destination email address jsmith@hotmail.com simply by sending a text message to the alpha address jsmith and the prefix (in this case jsmith) could currently be up to 11 characters long.

In a further embodiment, telephone numbers (fixed or mobile) may be represented as a shortform. A different character from ‘@’ may be used (e.g. ‘!’) to indicate that the shortform should be translated to a telephone number rather than an email address. In this case, instead of a domain name, a company name is preferably used as exemplified in the following table:

| Company name | Possible shortform |
|---|---|
| Vodafone | !vf |
| Telsis | !t |

The desired destination number may then be reached by addressing a text message to either the person's company extension number, or some representation of their name such as their initials. Examples are given in the following table illustrating possible ways to use this type of technique, but other variants are possible.

| Short form | | |
|---|---|---|
| Alphanumeric | | |
| address | Network translates to | Comments |
| 4410!vf | 07890 123456 | Telephone number of person at |
| | | Vodafone whose extension |
| | | number is 4410 |
| abc!t | 07803 760123 | Telephone number of A B |
| | | Clarke at Telsis Ltd |

Extension numbers and peoples' initials are generally 4 characters or less, while alpha addresses support up to 11 characters. This leaves 7 characters for the ! or @ plus the abbreviation of the company name.

Where a duplicate short form or ambiguity exists, for example due to two people in the same company having the same initials, the system could return a text message to the originator listing additional unambiguous short forms and their translations, allowing the user to try again.

It is also possible to apply the techniques described to numeric as well as alphanumeric addresses. For example the short form address 123* is enterable and accepted on most phones as a numeric address. This could be used as a short form to represent a full address, which might be a telephone number, an email address, or the like.

The methods so far presented may be combined, so that for example, both email address and/or telephone numbers may be stored against short form alphanumeric addresses in the network database. The user could choose the delivery address and medium by, for example, choosing to use @ or ! in the short form address, meaning email or text message respectively. The system could default to using an alternative address and medium of delivery if the requested one was not available.

Key advantages of the invention over the prior art are that text messages or emails may be sent to colleagues in the same or another organisation without the user having to know a full email address or telephone number of the person. No correlation mechanism for replies to email is required in the network, and so no unique address range needs to be reserved for generating CLIs for this purpose.

Other possibilities exist for message destinations that may be specified indirectly as described, using an alphanumeric address that does not exceed 11 characters. For example one could envisage sending a message to a car registration number to report a problem or to make contact with a driver. In the UK, registration numbers are a maximum of 7 characters long, containing both letters and numbers. One may conceive of services, perhaps aimed at drivers, where the participant provides a registration number as a means of entry into a competition or other event. The service provider then has the means to tie up the registration number with other contact details provided such as a name and address, thereby forming a database. The service provider can then offer services whereby such registered participants are contactable for other purposes by means of messages sent to their registration number.

Embodiments of the invention will now be described, by way of example only, with reference to the accompanying single FIGURE drawing which shows a block diagram of a telecommunications services apparatus according to an embodiment of the invention.

Referring to the single FIGURE drawing, the user of a mobile telephone is connected to a mobile network via a mobile switching centre (MSC) 1. Short messages originated by the user pass through an SMS router 2 or equivalent means for diverting certain messages. The SMS router 2 identifies certain messages according to their characteristics, and routes these messages to a message processing means 3. Other messages follow the normal path through the network and are delivered either directly to a destination MSC 7 or via a short message service centre (SMSC) 4 for store and forward delivery. The message processing means 3 is operable to generate a response message, which is delivered back to the originator via the SMS router 2. If immediate delivery of the response is not possible, the message may be passed from the SMS router 2 to the SMSC 4 for store and forward delivery. Alternatively the message processing means 3 may be operable to send the processed message via an email gateway 5 where the message is converted to email format and delivered via an email network to a recipient email system 6. The recipient email system 6 may generate an email reply, in which case this is delivered via the email gateway 5, which converts the reply to SMS format and passes it to the message processing means 3. The reply is then delivered to the originator either directly via the SMS router 2, or by a store and forward method using the SMSC 4.

Suitable equipment to be used as the SMS router 2 is a Telsis (RTM) SMS Router, manufactured by Telsis Limited. This equipment may connect to mobile telephone networks using standardised signalling protocols including SS7 and TCP/IP.

The operation of the embodiment shown in the drawing is now described in detail by means of a specific example.

In this example recipients on the ubiquitous ‘Hotmail’ Internet based email system are made reachable from any GSM mobile telephone network by means of text messages sent to an alphanumeric address ending in ‘@’. Other characters or syntaxes are possible. Although presently there is a restriction of 11 characters in GSM for alphanumeric addresses, leaving 10 plus @ for the Hotmail address prefix, this is sufficient for a majority of Hotmail account names. With in excess of 6 million billion possible addresses formable from 10 characters, there is plenty of scope yet for new addresses to be created that are also suitable for use with this invention.

Furthermore the email recipient is able to reply to the message, and have the reply delivered back to the originating mobile telephone as a text message.

In the following example, a GSM mobile telephone user with telephone number 07123 123456 wishes to send an email message from his mobile telephone to Hotmail user zcbmljgd27hotmail.com.

Using SMS, the sender composes his message, and sends it in the normal way, but specifying an alphanumeric destination address. This is achievable on most Nokia (RTM) phones by using ‘Send by Set’, or ‘Send Options’ then choosing a profile, and subsequently selecting ‘Alphanumeric’. Methods vary on other types of phone. The alphanumeric address zcbmljgd27@ is then entered and the message sent.

The network is configured, as shown in the drawing, so that the message passes through the SMS router 2 en route to the SMSC 4. This configuration is normally achieved by assigning the global title of the SMSCs to the SMS routers, thereby causing all MSCs to direct mobile originated (MO) text messages to an SMS router.

The SMS router 2 examines each message, and on determining that the address is formatted with an alphanumeric type of address, passes the message to the message processing means 3.

The message processing means 3 determines that in this case the particular destination address indicates that the message is to be delivered by email to a Hotmail address. This determination may be made by means of an algorithm, a lookup table, a database or other means that recognises that the syntax of an alphanumeric address ending with ‘@’ signifies a Hotmail destination. The message processing means 3 also determines the new origination address and destination email address to be used.

A new origination address is required in order to ensure that any reply returns via a desired route, which in this example is back through the message processing means 3. In this example the new origination address is created by including the user's CLI (07123 123456) along with an email domain name corresponding to the email gateway, forming the address 07123123456@<EMAILGATEWAYDOMAIN.COM>Many other suitable forms of address are possible.

A new destination address is required in order to deliver the message to the appropriate Hotmail address. Characteristics of the desired destination address may be algorithmically derived or looked up in a table or database using the original destination address zcbmljgd27@. In this example the new destination address is zcbmljgd27@hotmail.com

The message is now passed to the email gateway 5 where it is converted to email format and delivered via an email network to the recipient email system 6.

The message properties at this point are—

| | |
|---|---|
| Originating address | 07123123456@<EMAILGATEWAYDOMAIN. |
| | COM> |
| Destination address | zcbmljgd27@hotmail.com |
| Content | Are you coming to the party tonight? |
| Format | Email |

The primary purpose of the proposed technique has now been demonstrated, which is to allow a user to deliver a message to an appropriate email address using only a text message to an abbreviated Hotmail address. Furthermore, the CLI of the sender is now available to the recipient.

The secondary purpose of the technique is to permit a reply, or origination, path from recipients back to mobile subscribers. Using a reply to the previous case as an example, this works as follows.

The reply may be sent using the normal reply facilities of standard email systems, whereby the origination address of a message is automatically used as the default reply address.

The reply properties at this point are—

| | |
|---|---|
| Originating address | zcbmljgd27@hotmail.com |
| Destination address | 07123123456@<EMAILGATEWAYDOMAIN. |
| | COM> |
| Content | Yes, I'll be there. |
| Format | Email |

This message arrives at the email gateway 5, is converted to text message format and passed to the message processing means 3. The message addresses are then further transformed to be appropriate for the mobile telephone network, and to permit further reply by the user.

The user's telephone number is extracted from the email destination address.

The reply properties at this point are—

| | |
|---|---|
| Originating address | zcbmljgd27@ |
| Destination address | 07123123456 |
| Content | Yes, I'll be there. |
| Format | SMS |

zcbmljgd27@ is returned as the alphanumeric CLI of the reply, so that the user can easily send a further response.

Security issues are important for an email reply path, as with all systems that allow SMS messages to be initiated from the Internet. It is desirable for the mobile network operator to be able authenticate traffic with a source address indicating a domain name of Hotmail for example as genuinely originating from there. It is also desirable to be able to block unauthorised traffic from the Internet from obtaining access to mobile subscribers via the apparatus. Known prior art techniques such as digital signatures can be employed to provide the desired level of security. Using such techniques the mobile network is able to control and police the access to the apparatus. If desired, traffic arriving at the gateway may be restricted to replies to previously originated messages from mobiles, or alternatively, particular destinations may be allowed also to originate messages to subscribers.

In so far as the embodiments of the invention described above may be implemented, at least in part, using software-controlled processing apparatus, it will be appreciated that a computer program providing such software control and a storage medium by which such a computer program is stored are envisaged as aspects of the invention.

1-36. (canceled)

37. Telecommunications services apparatus for use with a mobile telephone network utilising a first message delivery function, the apparatus comprising routing means for identifying a characteristic in a message signal received in the telephone network, and message processing means for translating a short form destination address in the message signal into a full destination address for a second message delivery function, the address translation being effected using a predefined syntax, and the routing means being operable to send the message signal to the message processing means in response to identification of the characteristic in the message signal, wherein the characteristic in the message signal to be identified by the routing means is when the destination address is in alphanumeric form, and wherein the alphanumeric destination address is carried within an SMS destination address field.

38. Apparatus according to claim 37, including message delivery means for forwarding the message signal to the translated full destination address according to the second message delivery function, the message delivery means being additionally operable to receive a reply message signal from the original destination address and to forward the reply message signal to the message processing means for enabling translation of the reply destination address into accord with the first message delivery function such that the reply message signal may be sent to the originator of the original message signal.

39. Apparatus according to claim 37, wherein the first message delivery function is a mobile network text message function.

40. Apparatus according to claim 39, wherein the mobile network text message function is in accordance with the short message service (SMS).

41. Apparatus according to claim 37, wherein the second message delivery function is an email function.

42. Apparatus according to claim 41, wherein the translation according to the predefined syntax involves adding a specific service provider email domain to the short form destination address.

43. Apparatus according to claim 42, wherein the translation according to the predefined syntax is invoked when the short form destination address includes one or more predetermined characters.

44. Apparatus according to claim 43, wherein the translation according to the predefined syntax is invoked when the short form destination address ends with the one or more predetermined characters.

45. Apparatus according to claim 44, wherein the predetermined character is “@”.

46. Apparatus according to claim 44, wherein the predetermined characters are “@” followed by one or more other characters identifying corresponding specific service providers to enable translation to the respective service provider email domain.

47. Apparatus according to claim 37, wherein the second message delivery function is a VPN function.

48. Apparatus according to claim 47, wherein the second message delivery function is in accordance with the short message service (SMS).

49. Apparatus according to claim 47, wherein the translation according to the predefined syntax is invoked when the short form destination address includes one or more predetermined characters.

50. Apparatus according to claim 49, wherein the translation according to the predefined syntax is invoked when the short form destination address ends with the one or more predetermined characters.

51. Apparatus according to claim 50, wherein the predetermined characters are “!” followed by one or more characters identifying corresponding VPNs.

52. Apparatus according to claim 37, wherein the routing means comprises an SMS router.

53. A telecommunications services method for a mobile telephone network utilising a first message delivery function, the method comprising identifying a characteristic in a message signal received in the telephone network, and translating a short form destination address in the message signal into a full destination address for a second message delivery function, the address translation being effected using a predetermined syntax, and the message signal being routed for message processing in response to identification of the characteristic in the message signal, wherein the characteristic in the message signal to be identified is when the destination address is in alphanumeric form, and wherein the alphanumeric destination address is carried within an SMS destination address field.

54. A method according to claim 53, including forwarding the message signal to the translated full destination address according to the second message delivery function, receiving a reply message signal from the original destination address, and forwarding the reply message signal for message processing to enable translation of the reply destination address into accord with the first message delivery function such that the reply message signal may be sent to the originator of the original message signal.

55. A method according to claim 53, wherein the first message delivery function is a mobile network text message function.

56. A method according to claim 55, wherein the mobile network text message function is in accordance with the short message service (SMS).

57. A method according to claim 53, wherein the second message delivery function is an email function.

58. A method according to claim 57, wherein the translation according to the predefined syntax involves adding a specific service provider email domain to the short form destination address.

59. A method according to claim 58, wherein the translation according to the predefined syntax is invoked when the short form destination address includes one or more predetermined characters.

60. A method according to claim 59, wherein the translation according to the predefined syntax is invoked when the short form destination address ends with the one or more predetermined characters.

61. A method according to claim 60, wherein the predetermined character is “@”.

62. A method according to claim 60, wherein the predetermined characters are “@” followed by one or more other characters identifying corresponding specific service providers to enable translation to the respective service provider email domain.

63. A method according to claim 53, wherein the second message delivery function is a VPN function.

64. A method according to claim 63, wherein the second message delivery function is in accordance with the short message service (SMS).

65. A method according to claim 63, wherein the translation according to the predefined syntax is invoked when the short form destination address includes one or more predetermined characters.

66. A method according to claim 65, wherein the translation according to the predefined syntax is invoked when the short form destination address ends with the one or more predetermined characters.

67. A method according to claim 66, wherein the predetermined characters are “!” followed by one or more characters identifying corresponding VPNs.

68. A method according to claim 53, wherein the message signal routing is performed by an SMS router.

69. A computer program for implementing a method according to claim 53.

70. A storage medium storing a computer program according to claim 69.
